(19) United States
(12) Patent Application Publication
(10) Pub. No.: US 2007/0220519 A1
(43) Pub. Date: Sep. 20, 2007

(54) Exclusive control method in a multitask system

(75) Inventors: Tomotake Koike, Chiba (JP); Minehiro Oota, Saitama (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/713,020

(22) Filed: Mar. 2, 2007

(30) Foreign Application Priority Data
Mar. 3, 2006 (JP) 2006-058438

(51) Int. Cl. G06F 9/46

(52) U.S. Cl. 718/102

(57) ABSTRACT

In an exclusive control method in a multitask system in which a single CPU executes events generated in a congested state under an exclusive control by a service-providing program running under the system, an exclusive group is defined, which comprises an exclusive-control object having one or more service objects belonging thereto contained, which are necessary to provide the service to the same providee. The events are separated into a priority event and a non-priority even to be queued, respectively, in a priority-event queue in the exclusive-control object and a non-priority-event queue in the service object, on the basis of their respective execution urgency. The non-priority-events are provided with link. The exclusive-control object executes preferentially the priority-event to the non-priority-events when the exclusive group obtains an execution right.

### BACKGROUND OF THE INVENTION

1. Field of the Invention

The present invention relates to an exclusive control method in a multitask system. More specifically, the present invention relates to an exclusive control method advantageously applicable to a communications server for providing a plenty of subscribers with subscriber services, such as an IP (Internet Protocol) telephone service, which a variety of events may be caused in a congested state to establish.

2. Description of the Background Art

A general asynchronous communications system has a server, such as a communications server providing IP telephone services, which allocates a context to an inputted event to process, in a multiple thread structure, a variety of events, such as call originations from and terminations to a lot of subscribers, generated in a congested state. In the specification, the words “multiple or multi- thread” may be broadly comprehended to cover the possibility of threads as well as processes. A higher-level resource such as a service object providing a subscriber service is accessed with an exclusive control process using a lock primitive such as the mutex in order not to cause the reentry of a context to destruct data. See, for example, U.S. Pat. No. 6,161,147 to Snyder et al, and Japanese patent laid-open publication Nos. 044368/1997 and 101901/1997. Also, for the exclusive control, reference may be made to the web sites, http://www.hlla.is.tsukuba.ac.jp/˜yas/sie/pdsoft-2000/2001-01-18/ and http://www.valinux.co.jp/docs/pdf/VABF2003/VABF T01.pdf.

For example, considering a call origination, differences in process and priority reside between a call originated when a subscriber A is connected to another subscriber B (event X) and a call originated when the subscriber A is not busy (event Y). In addition, the process and priority during call origination are different also in dependent upon whether or not the subscriber A contracts a call-waiting telephone service (event X1 or X2). The processes and the priorities of events are thus different from one case to another, so that exclusive control process is required.

The ordering or priority of events may be provided corresponding to the priority of contexts, but this ordering depends on a particular system. The ordering is thus implemented by constructing a queue on a specific application. The queue length usually needs to be set longer to a certain extent designed in consideration of a possible congestion of events.

An exclusive control such as the collective mutex merely avoids the collision of contexts, so that an excluded context has to wait for a completion of the process of a context going on. It thus takes long time to transfer the event to the service object so that the collective mutex is not applicable to a server adapted for a type of system, such as an IP telephone system, which requires the continuity or quality of services.

The queue for ensuring the order is a one-dimensional array and has a finite queue length. Therefore, for example, when a plurality of service objects are simultaneously generated to cause corresponding events, the queue overflows with those events, which will thus be lost.

Although a model may be applied where a queue array is dynamically generated and secured, a system having its system memory area limitative needs to control the queue size, with a result that a memory manager is required to recognize a condition for generating service objects, which is unsuitable for a model under object-orientated development. As described above, it is very difficult to establish in advance the structural arrangement of a queue so as to be in conformity with the property and operational condition of a service to be provided.

Moreover, with a context that has an event input and output to and from a queue, securing the ordering requires arranging for each queue one input event and one output event associated with the context. This will be the bottleneck of the performance in processing events generated in a congested state.

When deleting or modifying an event directed to a certain object already queuing in an event queue, an ordinary queue array requires a linear search from the top of the queue. Events generated in a congested state may cause the queue length longer to the extent that the linear search cannot ensure the process time rated.

### SUMMARY OF THE INVENTION

It is an object of the present invention to provide an exclusive control method for a multitask system, which is advantageously applicable to a system for subscriber service, such as IP telephone service, which serves great many users each of which is provided with a variety of events for establishing services in a congested state.

In accordance with the present invention, an exclusive control method for a multitask system in which a single main controller executes events under an exclusive control according to an service-providing program, the events being generated in a congested state, includes the steps of: defining an exclusive group having one or more service objects belonging thereto that are necessary to provide the service to the same providee and an exclusive-control object that includes the one or more service objects; separating the events, according to their respective urgency of execution, into a priority event having a process executed preferentially and a non-priority event; allowing each of the service objects to have a non-priority-event queue that accommodates a non-priority event associated with the service object; providing a link over all non-priority events in the relevant exclusive group, which are queued in the non-priority-event queues in the service objects; allowing the exclusive-control object to have a priority-event queue that accommodates a priority event; and executing preferentially the priority-event queue queued in the priority-event queue than the non-priority events which are provided with the link and queued in the non-priority-event queues of the service objects.

### BRIEF DESCRIPTION OF THE DRAWINGS

The objects and features of the present invention will become more apparent from consideration of the following detailed description taken in conjunction with the accompanying drawings in which:

FIG. 1 exemplarily illustrates how events are ordered for each exclusive group in an illustrative embodiment according to the present invention;

FIG. 2 is a schematic block diagram showing an example of the hierarchy of a multitask processor in the illustrative embodiment;

FIG. 3 schematically illustrates an example of linkage between non-priority events in the illustrative embodiment;

FIG. 4 is a flowchart useful for understanding a specific procedure executed by the illustrative embodiment for executing a priority event preferentially to a non-priority event;

FIG. 5 schematically illustrates an example of removing a service object;

FIG. 6 is a flowchart useful for understanding a specific procedure executed by the illustrative embodiment for removing a service object from an exclusive group shown in FIG. 5;

FIGS. 7A, 7B and 7C schematically illustrate an example of deleting from a queue array a non-priority event directed to a removed object in the illustrative embodiment;

FIGS. 8A and 8B schematically illustrate an example of coupling the exclusive groups in the illustrative embodiment;

FIGS. 9A and 9B schematically illustrate another example of coupling the exclusive groups in the illustrative embodiment;

FIG. 10 is a flowchart, like FIG. 4, useful for understanding a specific procedure executed by the illustrative embodiment for executing a priority event preferentially to a non-priority event in a coupled exclusive group;

FIGS. 11A and 11B schematically illustrate an example of separating the exclusive groups in the illustrative embodiment; and

FIGS. 12A and 12B schematically illustrate an example of moving the object in the coupled exclusive groups in the illustrative embodiment.

### DESCRIPTION OF THE PREFERRED EMBODIMENT

A preferred embodiment of a multitask system in accordance with the present invention will be described in detail below with reference to the accompanying drawings. Note that the instant illustrative embodiment is specifically directed to a multitask processor provided in a call agent or communications server in an IP (Internet Protocol) telephone system.

The instant embodiment provides an exclusive-control object EXOB for optimizing the arrangement of a queue and a context in association with the form, aspect or nature of events inputted to a service object and also a base class for each service object, thus providing a grouping of the objects, the natural extension of the queue length when service objects increase in the group, and the allocation of the context without the lock processing.

The instant illustrative embodiment also provides a binding of an event-queue array with a service object to allow an immediate discovery of an event queue directed to or meant for the relevant object.

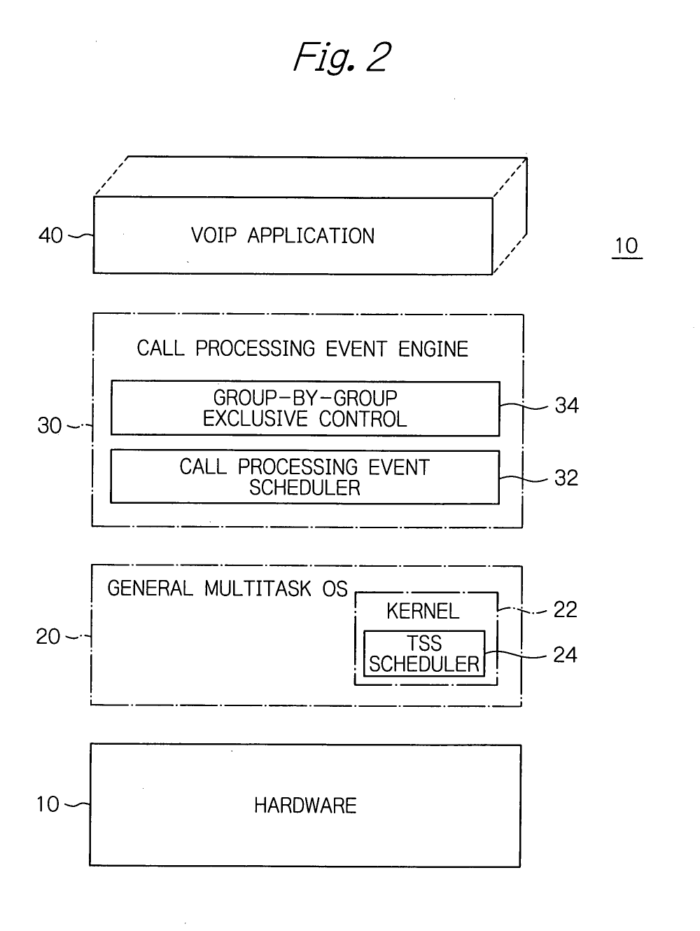

A description will be given below of the configuration of a multitask processor having the multitask system installed, as an exemplified call controller 10, FIG. 2, adapted for processing calls originated in a congested state.

The call controller 10 is applied to, for example, a call agent that handles a large number (equivalent to, e.g. 800,000 lines) of VoIP (Voice over Internet Protocol) signals transmitted to and from IP telephone sets or the like. The call controller 10 may be the same only in hardware configuration as a commonly known call agent. Specifically, the call controller 10 may comprises a main controller such as a central processor unit (CPU), a memory, a mass storage such as an internal hard disk drive (HDD), a keyboard, a pointing device such as a mouse, a display unit, a communication interface and the like, which are not specifically shown. The CPU is connected to the memory via a system bus which also connects together with input/output devices the CPU to the mass storage, keyboard, mouse, display, communication interface and the like.

The call controller 10 uses, for example, a general-purpose multitask OS (Operating System) 20 such as the Linux (trademark) or Windows (trademark), which includes a TSS (Time Sharing System) scheduler 24 in a kernel 22 as shown in FIG. 2. In the figures, elements not directly relevant to the understanding of the present invention are not shown, and detailed description thereof will not be made for simplicity.

As well as the TSS scheduler 24 in the kernel 22 in the multitask OS 20, the call controller 10 includes a call-processing event engine 30 located on a user layer. The engine 30 includes a scheduler function, such as a call-processing event scheduler 32, and an exclusive control function, such as a group-by-group exclusive control 34, shown in the figure. The TSS scheduler 24 handles, via the event engine 30, a thread associated with a VoIP application 40. In other words, the event scheduler 32 is a context that operates on the TSS scheduler 24 of the kernel 22.

In the illustrative embodiment, as will be described below, there are a plurality of exclusive groups, each of which serves as a unit for exclusive control, so that the event scheduler 32 operating on the TSS scheduler 24 of the kernel 22 is adapted to determine which exclusive group the execution right of the CPU is provided to in a manner known itself by U.S. patent application publication No. 2006/0143616A1 to Koike et al.

The group-by-group exclusive control 34 is adapted to manage, for each exclusive group, the ordering of events, and execute under the exclusive control a plurality of events in an exclusive group to which the execution right of the CPU is provided.

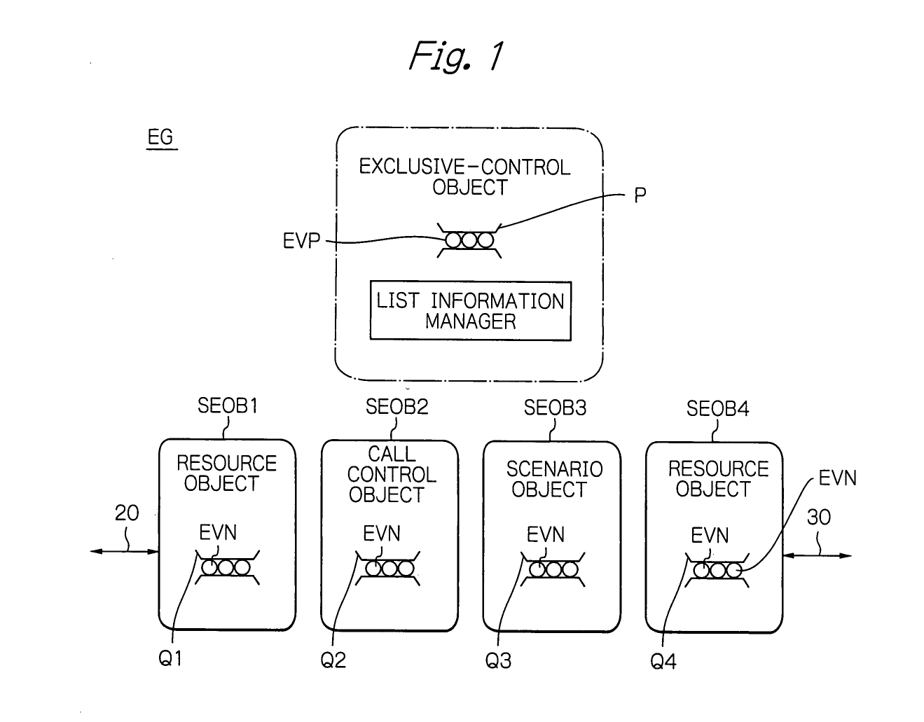

Reference will be made to FIG. 1 for describing the ordering of events specific for an exclusive group EG. FIG. 1 schematically illustrates the relation between objects and event queues in the exclusive group EG.

The exclusive group EG is an aggregate of objects that functions as a unit of exclusive control. For the call agent described above, each exclusive group generally corresponds to a call.

The exclusive group EG includes, as shown in FIG. 1, an exclusive-control object EXOB that is adapted to control the event execution in the exclusive group EG, and one or more service objects SEOB1 to SEOB4. FIG. 1 shows, byway of example, four service objects.

The exemplified exclusive group EG shown in FIG. 1 includes the four service objects SEOB1 to SEOB4 belonging to one exclusive group EG and the exclusive-control object EXOB controls the event execution.

The example shown in FIG. 1 is directed to the exclusive group in a call agent in which the service objects SEOB1 to SEOB4 are, respectively, a “resource object (on the side of call originator)” that is adapted to transmit and receive signals 20 to and from the IP terminal of a call originator, a “call-control object” that is adapted to execute a call-processing sequence, a “scenario object” that is adapted to process the transition of service to, e.g. three-party call service or call forwarding service, and a “resource object (on the side of call terminator)” that is adapted to transmit and receive signals 30 to and from the IP terminal of a call terminator. In the figures, signals are designated with reference numerals designating connections on which they are conveyed.

The service objects SEOB may increase or decrease in one exclusive group EG. More specifically, for example, the resource object (of a call originator) is not formed under the circumstances where the telephone number of a call terminator is not inputted. Whenever the telephone number is inputted and the corresponding thread is executed, the resource object (of a call originator) will be formed. Further, from the call connected condition, for example, when the IP telephone set on the side of call originator or terminator is on-hooked and the corresponding thread is executed, the resource object associated with the on-hooked IP telephone set is deleted or escapes from the group EG.

The exclusive-control object EXOB includes a list information manager LIS which is adapted to manage list information on the service objects SEOB1 to SEOB4 currently existing.

The exclusive group EG includes event queues of two priorities, “non-priority” and “priority”. In the illustrative embodiment, the event queues of non-priority are queues Q (Q1 to Q4) and the event queue of priority is a queue P.

The non-priority event queue Q is a queue array for a large number of events of non-priority EVN, such as input and output to and from the outside, which are not preferentially handled. The queue Q resides in the service objects SEOB1 to SEOB4. The non-priority events EVN are queued in the corresponding non-priority-event queues Q1 to Q4 in the service objects SEOB1 to SEOB4. The queue length of each of non-priority-event queues Q1 to Q4 is set to a value equal to the maximum number of the non-priority events EVN that are expected to be concurrently received when the service objects SEOB1 to SEOB4 exist. That may cause the queue lengths necessary for the service objects SEOB1 to SEOB4 to be different depending on the property of the respective service objects SEOB1 to SEOB4. However, the service objects SEOB1 to SEOB4 can thus acquire the necessary queue lengths. Additionally, when the group EG has a new service object SEOB generated and coupled to itself, the queue lengths in the entire exclusive group EG extend.

The generated non-priority event EVN is queued, as described above, in the non-priority-event queue Q in the execution-target service objects SEOB1 to SEOB4, and is also linked to the non-priority event EVN that has previously been queued at the end in the exclusive group EG.

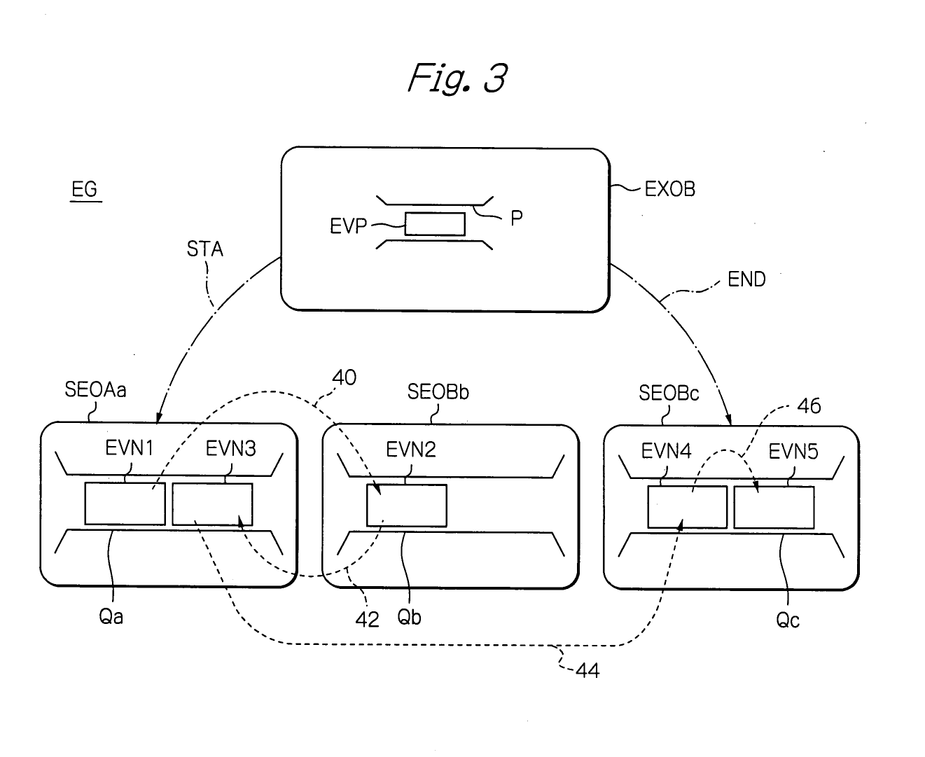

FIG. 3 schematically shows an example of linkage between the non-priority events EVN in the non-priority-event queues Q in the exclusive group EG. In the figure, service objects SEOBa to SEOBc and non-priority-event queues Qa to Qc are like the service objects SEOB1 to SEOB4 and non-priority-event queues Q1 to Q4 shown in FIG. 1, respectively, and will not be described specifically in order to avoid redundancy. In the illustrative embodiment, there are five non-priority-events EVN1 to EVN5 which are queued in corresponding non-priority-event queues Qa to Qc. More specifically, the non-priority events EVN1 and EVN3 associated with the service object SEOBa are queued in the non-priority-event queue Qa in the service object SEOBa. Similarly, the non-priority event EVN2 associated with the service object SEOBb and the non-priority events EVN4 and EVN5 associated with the service object SEOBc are queued in the non-priority-event queue Qb in the service object SEOBb and in the non-priority-event queue Qc in the service object SEOBc, respectively.

First, a description will be given of the case where there is not a non-priority event EVN5 but only four non-priority events EVN1 to EVN4. These four non-priority events EVN1 to EVN4 are linked in the order they are generated in order to define the processing order of the non-priority events. More specifically, in the illustrative embodiment, from the non-priority event EVN1 to the non-priority event EVN2, a link 40 is provided. Similarly, from the non-priority event EVN2 to the non-priority event EVN3 and from the non-priority event EVN3 to the non-priority event EVN4, links 42 and 44 are provided respectively.

The start and end positions of the links are managed by the exclusive-control object EXOB. More specifically, as shown in FIG. 3, the exclusive control object EXOB manages the position information STA on the non-priority event EVN1 at the start (#1) of the processing order and the position information END on the non-priority event EVN4 at the end of the processing order. In the illustrative embodiment, the start-position information STA, which is stored in the service object SEOB, is the identification information of the service object SEOBa associated with the start non-priority event EVNl and used in the case where the non-priority event EVN is dequeued from the relevant object and executed. Similarly, the end-position information END, which is also stored in the service object SEOB, is the identification information of the service object SEOBc associated with the end non-priority event EVN4. When the service object SEOB is defined, the start or end non-priority event EVN is uniquely set by the non-priority-event queue Q which exists within the service object SEOB so that the way for queuing the event queue as shown in FIG. 3 can be applied.

When the exclusive group EG has the non-priority event EVN5 generated newly in the exclusive group EG where the four non-priority events EVNl to EVN4 are already in being, the non-priority event EVN5 is queued in the non-priority-event queue Qc in the service object SEOBc associated with the relevant non-priority event EVN5, and is also liked to the non-priority event EVN4 that has previously been queued at the end position, i.e. from the non-priority event EVN4 to the non-priority event EVN5, a link 46 is provided. The end-position information END is then updated to the identifying information of the new non-priority event EVN5.

Rather than providing, for each service object SEOB, the non-priority-event queues Q (Q1 to Q4 in FIG. 1, Qa to Qc in FIG. 3), one non-priority-event queue may be provided for the entire exclusive group EG. In the illustrative embodiment where each service object SEOB is provided with the non-priority-event queue Q, it is however possible to switch dynamically the non-priority event order depending on the generation/escape of the object, and also switch dynamically the queue length of the entire exclusive group EG as necessary.

Referring again to FIG. 1, the priority event queue P is a queue array for a small number of preferentially handled events (priority events) EVP such as the events generated in the communication between objects in the exclusive group EG. One priority event queue P is assigned in the exclusive group EG and resides in the exclusive-control object EXOB. The priority-event queue P is immediately executed so that only one priority event EVP is generated except when one event generates a plurality of priority events EVP. It is thus possible to provide a minimum memory resource by setting the queue length for each exclusive group EG.

The priority event EVP is preferentially executed to the non-priority event EVN of each service object SEOB in the exclusive group EG. When, for example, the service object SEOBa, FIG. 3, in the exclusive group EG transmits an event to the service object SEOBb, the relevant event is queued as the priority event EVP in the priority-event queue P in the exclusive-control object EXOB. When the context returns to the exclusive-control object EXOB after the service object SEOBa completes its process, the exclusive-control object EXOB extracts the event EVP of the service object SEOBb from the priority-event queue P to transfer the event to the service object SEOBb for processing the event. When, during the process of the priority event EVP of the service object SEOBb, the service object SEOBb externally receives the non-priority event EVN, the non-priority event EVN is immediately queued in the non-priority-event queue Qb in the service object SEOBb, but is loosely-coupled to the priority-event queue P in the exclusive-control object EXOB, so that the non-priority event is executed after the process of the priority event is complete.

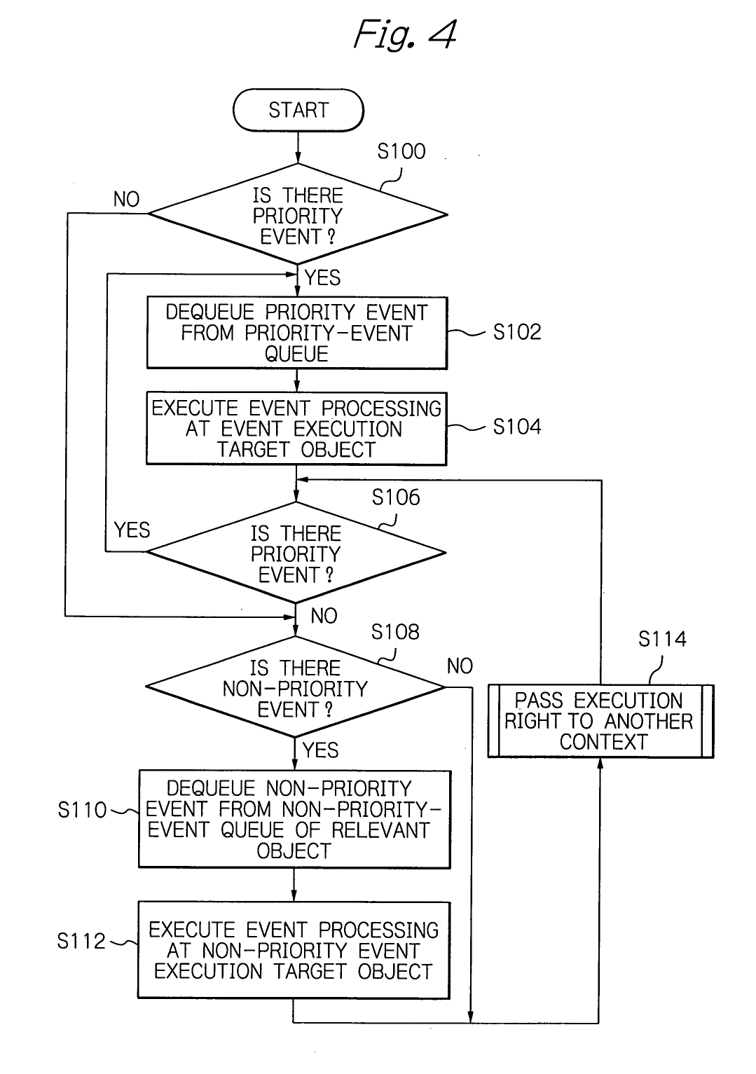

FIG. 4 is a flowchart demonstrating a specific procedure available with the illustrative embodiment for executing the priority event EVP preferentially to the non-priority event EVN. The priority event EVP and non-priority event EVN are executed under the control of the exclusive-control object EXOB.

The exclusive-control object EXOB first determines whether or not the relevant exclusive group EG has the priority event EVP by checking the priority-event queue P of the exclusive-control object EXOB (step S100). If the priority-event queue P has the priority event EVP queued therein (Yes, step S100), then the exclusive-control object EXOB dequeues the first queued event (step S102), and passes the priority event EVP to the event-executing service object to have it processing the event (step S104).

When the event processing as described above is completed and the control returns to the exclusive-control object EXOB, the exclusive-control object EXOB checks again its priority-event queue P so as to determine whether or not the priority event EVP still exists (step S106). If there is the priority event EVP (Yes, step S106), then the exclusive-control object EXOB repeatedly executes the same process as described above (steps S102 and S104).

Conversely, if the priority-event queue P has no priority event EVP from the beginning (No, step S102), or all processes associated with the priority event EVP present in the priority-event queue P are executed with no priority event EVP left in the priority-event queue P (No, step S106), then the exclusive-control object EXOB processes the non-priority event EVN.

In the process of the non-priority event EVN, the exclusive-control object EXOB first determines whether or not the non-priority event EVN exists (step S108). In the illustrative embodiment, the exclusive-control object EXOB uses for the determination the start information STA of the non-priority event link in the exclusive-control object, in which information valid information is described when non-priority events EVN are linked in the order they are executed. The exclusive-control object EXOB thus determines whether or not the start information STA has the valid information described in it.

If the non-priority event EVN exists in the non-priority-event queues Q of the service objects (Yes, step S108), then the exclusive-control object EXOB dequeues the non-priority event EVN from the non-priority-event queue Q of the service object SEOB on the basis of the start information STA of the non-priority event link (step S110) and has the relevant service object SEOB processing the dequeued non-priority event EVN (step S112). Note that, during the dequeuing, the exclusive-control object EXOB may, e.g. rewrite the start information STA of the non-priority event link.

Conversely, if there is no non-priority event EVN (No, step S108) or if the process of the non-priority event EVN has completed so as to return the control to the exclusive-control object EXOB, then the exclusive-control object EXOB releases the execution right (step S114). In other words, the exclusive-control object EXOB passes the execution right to other context (for example, another exclusive group).

When the execution right returns to the relevant exclusive group, the exclusive-control object EXOB executes the same procedure as described above.

As described above, the priority event EVP overrides the non-priority event EVN if both exist in the same exclusive-control object EXOB, i.e. when the execution right provided, the priority event ENP is always processed first, and the non-priority event EVN is processed under the circumstance where there is no priority event ENP in the exclusive-control object EXOB.

A description will now be given of the service object SEOB that is removed from the configuration of the exclusive group EG for reasons of the service conditions.

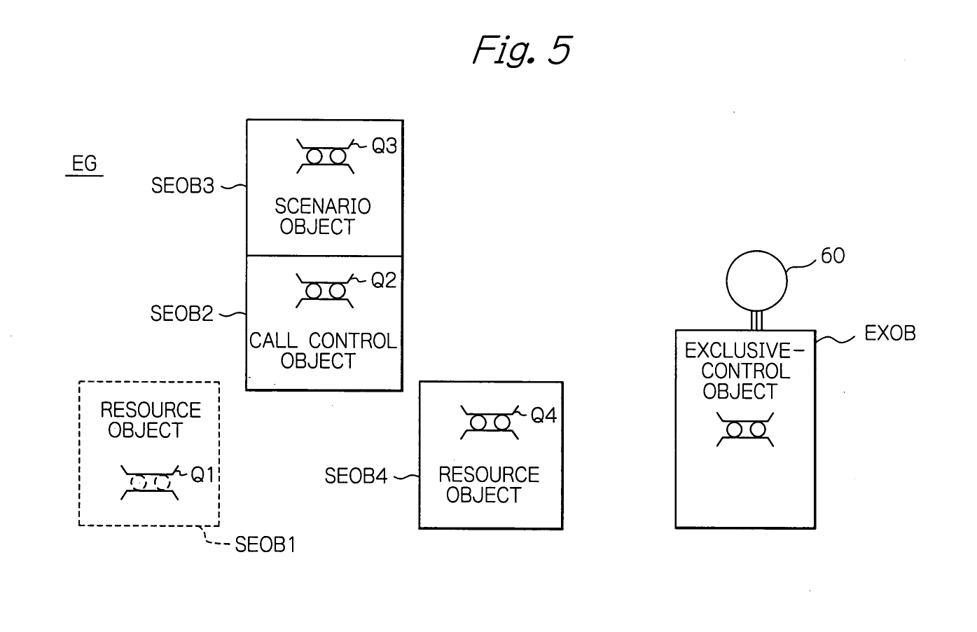

There is a case where the service object SEOB escapes from the exclusive group EG for reasons of the service conditions such as necessity to modify the service form. Reference will be made to FIG. 5 for describing the escape of the service object SEOB from the exclusive group EG. In the figure, structural parts and elements like those shown in FIG. 1 are designated by identical reference numerals, and will not be described specifically in order to avoid redundancy. In the figure, for example, in the exclusive group EG associated with a telephonic connection established between subscribers A and B, when the subscriber A breaks the connection during the telephone conversation, the resource object SEOB1 that controls giving and receiving a signal to and from the subscriber A is removed from the exclusive group EG as depicted with a dashed box in the figure.

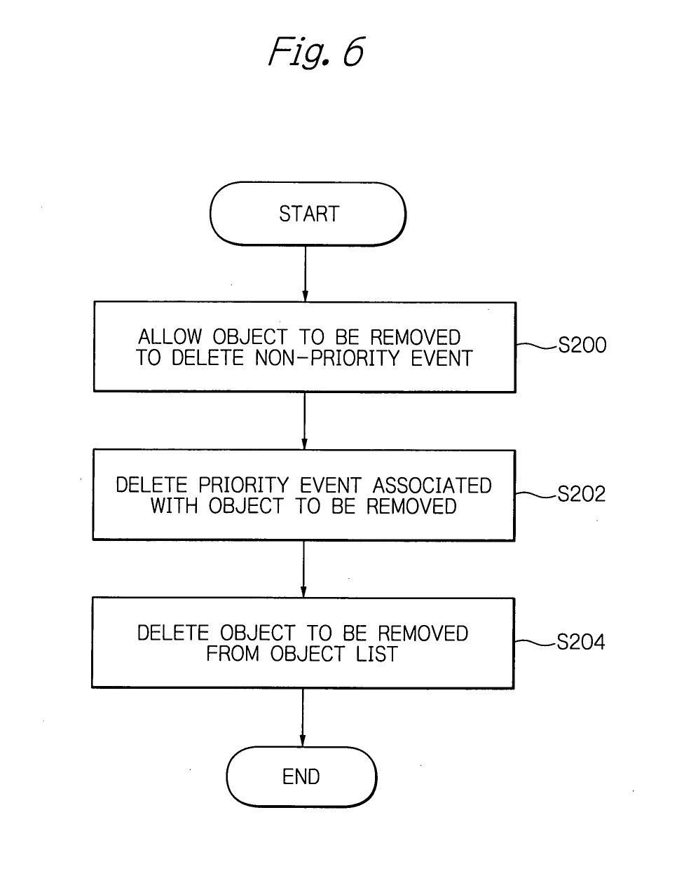

FIG. 6 is a flowchart demonstrating a specific procedure available with the illustrative embodiment for removing the resource object SEOB1 from the exclusive group EG. The process during the removal is executed under the control of a thread 60, FIG. 5, for controlling removal in the exclusive-control object EXOB.

In FIG. 6, the object SEOB1 to be removed deletes the non-priority event EVN inputted to itself from the array of the non-priority-event queue Q1 (step S200). Then, from the array of the priority-event queue P in the exclusive-control object EXOB, the priority event EVP related with the object SEOB1 to be removed is deleted (step S202). After all events EVN and EVP for the object SEOB1 to be removed are deleted from the arrays of queue P and Q1, respectively, the service object SEOB1 is deleted from the object list stored in the exclusive-control object EXOB (step S204), thus successfully removing the service object SEOB1 from the exclusive group EG.

Along with deleting the non-priority event EVN from the array of the non-priority-event queue Q, procedure for the remaining non-priority events EVN may be performed, e.g. procedure of providing a new link for them and updating the start-position information STA and final position information END of the link.

Note that the service object SEOB can be added only by writing in the object list in the exclusive-control object EXOB. Immediately after the addition, the events EVN and EVP may also be written in the arrays of the queues P and Q as necessary.

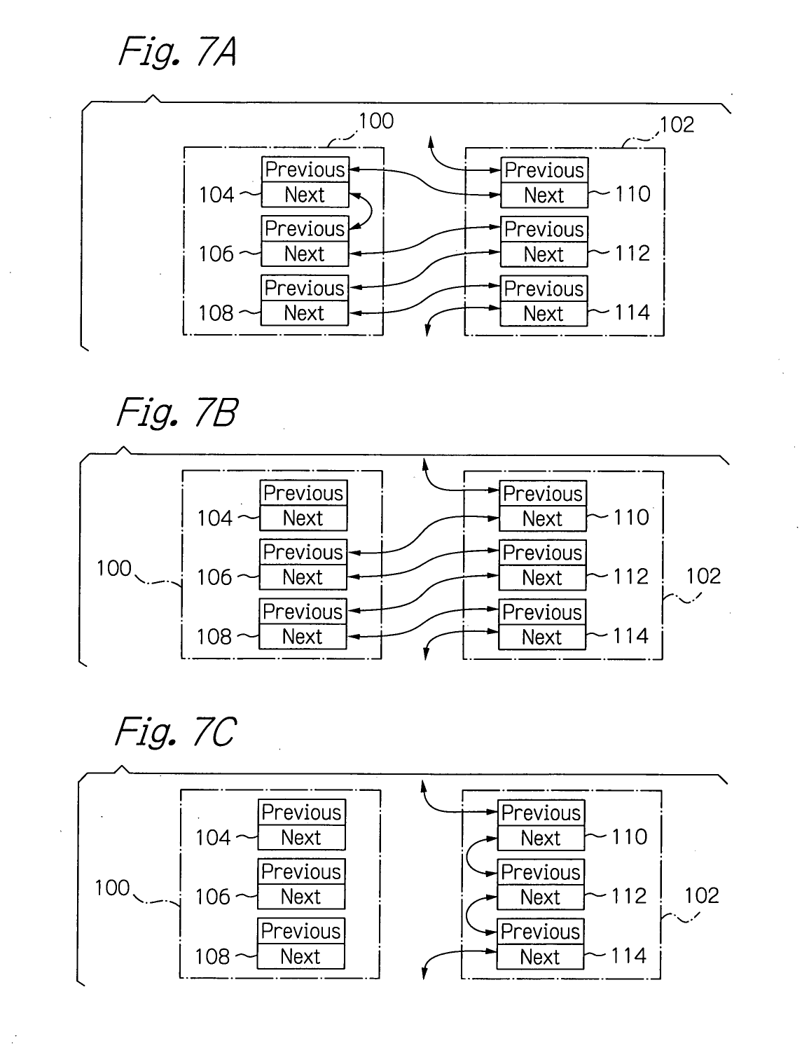

Reference will be made to FIGS. 7A, 7B and 7C for describing a specific method of deleting from the queue array of the non-priority-event queue the non-priority events of the service object to be removed.

FIGS. 7A, 7B and 7C show two non-priority-event queues 100 and 102 of two service objects from which the object of the non-priority-event queue 100 is removed. The non-priority-event queues 100 and 102 are like the non-priority-event queue Q in FIG. 5 and will not be described specifically in order to avoid redundancy. The non-priority-event queues 100 and 102 have non-priority events 104 to 108 and 110 to 114, respectively, which are linked, as indicated by the arrows in FIG. 7A, so as to be managed for the order of them. Each of the non-priority events 104 to 114 also stores position information on the previous and next non-priority events. When the non-priority events 100 are deleted from the queue array of the non-priority-event queue of the service object to be removed, the information on the previous and next non-priority events are updated whereby the target non-priority event is deleted.

More specifically, when the start non-priority event 104 is deleted, the non-priority event 110 written by the non-priority event 104 as the previous non-priority event is directly linked to the non-priority event 106 written by the non-priority event 104 as the next non-priority event, as shown in FIG. 7B, thus removing the start non-priority event 104.

Similarly, when the next non-priority event 106 is deleted, which has become the new start non-priority event, the non-priority event 110 written by the non-priority event 106 as the previous non-priority event is directly coupled to the non-priority event 112 written by the non-priority event 106 as the next non-priority event, thus removing the non-priority event 106. In other words, the previous and next non-priority events of the target non-priority event are directly linked by means of the position information stored in the target non-priority event.

The same atomic process is repeated until all the non-priority events 104 to 108 in the object 100 to be removed have disappeared as shown in FIG. 7C. When the chain handlings in the queue of the relevant object are complete, all events for the object to be removed are processed.

A description will next be given of the coupling and separation of the exclusive group EG. The coupling of the exclusive groups means that a plurality of exclusive groups each of which provides a different service are event-controlled as one exclusive group to provide a new service. For example, assuming that there are a first exclusive group associated with a call service between a subscriber A who contracts a call-waiting telephone service and a subscriber B, and a second exclusive group immediately after another subscriber C starts a calling process, and the subscriber C then inputs the telephone number of the subscriber A as a called party, or destination, then the first and second exclusive groups are coupled.

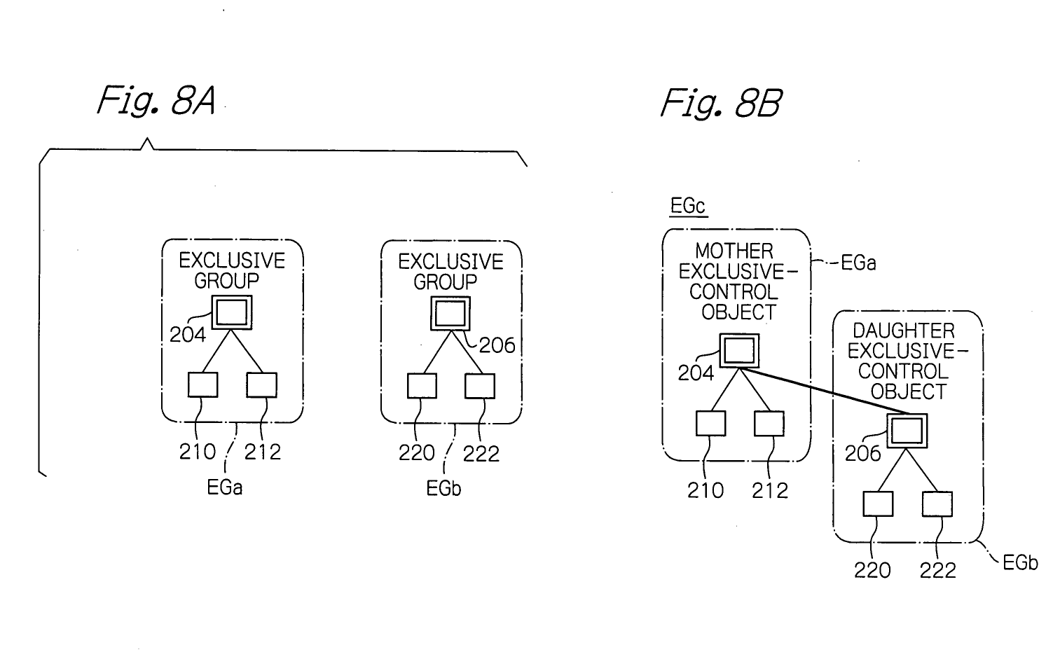

Reference will be made to FIGS. 8A and 8B for describing a specific coupling of the exclusive groups EG. FIG. 8A shows two exclusive groups EGa and EGb which are like the exclusive group EG shown in FIG. 1 and have the exclusive-control objects 204 and 206 and service objects 210, 212 and 220, 222, respectively, which are like the exclusive-control object EXOB and service object SEOB, respectively.

The coupling of the exclusive groups EG causes, as shown in FIG. 8B, the exclusive-control object 204 of one exclusive group EGa to be a mother exclusive-control object, and the exclusive-control object 206 of the other exclusive group EGb to belong to, as a daughter exclusive-control object, the mother exclusive group Ega, thus forming a coupled exclusive group EGc.

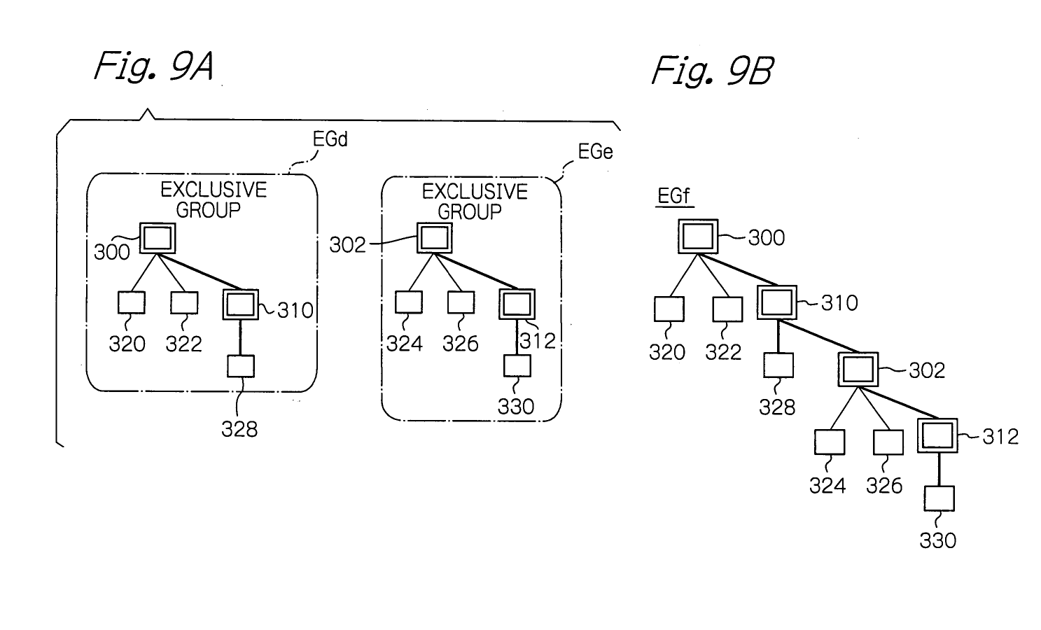

It is also possible to couple an already-coupled exclusive group and another already-coupled exclusive group, and an already-coupled exclusive group and other exclusive group. Reference will be made to FIGS. 9A and 9B for describing a specific coupling of already-coupled exclusive groups. FIG. 9A shows two exclusive groups EGd and EGe which have already coupled with two exclusive group EG like the exclusive group EGc shown in FIG. 8, and have the mother exclusive-control objects 300, 302, daughter exclusive-control objects 310 and 312 and service objects 320 to 330, respectively. The service objects 320, 322 and 324, 326 are associated with the mother exclusive-control objects 300 and 302 respectively, and the service objects 328 and 330 are associated with the daughter exclusive-control objects 310 and 312, respectively.

For example, the already-coupled exclusive group EGd and another already-coupled exclusive group EGe are coupled by, as shown in FIG. 9B, causing the lowest-level daughter exclusive-control object 310 of one already-coupled exclusive group EGd to be a mother exclusive-control object, and the mother exclusive-control object 302 of the other already-coupled exclusive groups EGe to be a daughter exclusive-control object, thus forming a newly-coupled exclusive group EGf.

It is determined in advance in a predetermined object processing the event whether or not the exclusive groups need to be coupled, which object is to be the mother exclusive-control object, and which object is to be the daughter exclusive-control object.

The coupled daughter exclusive-control object is handled in the same way as for the service objects under the same mother exclusive-control object. In the example in FIG. 8B, the mother exclusive-control object 204 of the coupled exclusive group EGc has the object list listed the identification information on the service objects 210 and 212 as well as on the daughter exclusive-control object 206.

The coupled exclusive group executes the event in substantially the same way as for one exclusive group, and the event-execution control in the coupled exclusive group is distributed from the mother exclusive-control object to the daughter exclusive-control objects in sequence.

For example, in FIGS. 8A and 8B, the event control in the exclusive group EGc is distributed from the mother exclusive-control object 204 to the daughter exclusive-control object 206. The event-execution order for the service objects 220 and 222 under the daughter exclusive-control object 206 is thus controlled as the event in the exclusive-control object 206 distributed from the exclusive-control object 204 so that the event-execution order in the coupled exclusive group EGc is maintained.

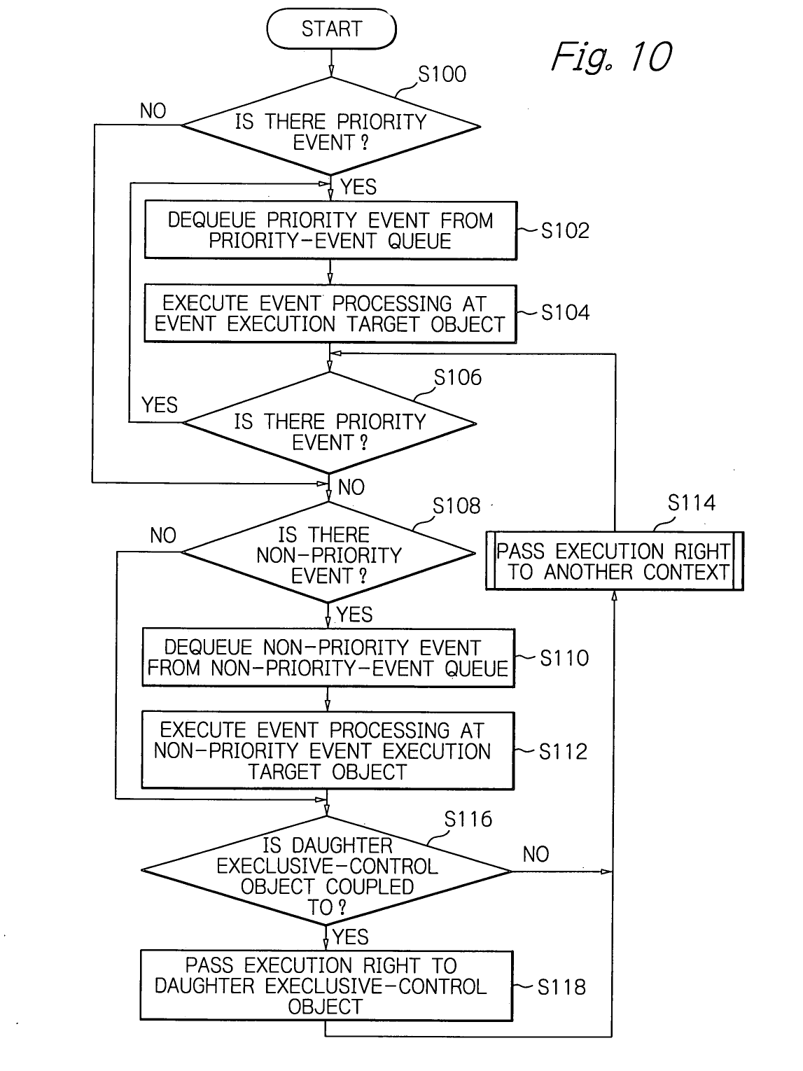

Well, FIG. 10 is a flowchart, like FIG. 4, of a specific procedure for controlling the event-execution in the coupled exclusive groups. In FIG. 10, steps like those shown in FIG. 4 are designated by identical reference numerals, and will not be described specifically again in order to avoid redundancy.

In FIG. 10, when no non-priority event EVN exists (NO, step S108) or when the process of the non-priority event EVN is complete and the control returns to the exclusive-control object in question, the exclusive-control object (mother exclusive-control object) determines whether or not the daughter exclusive-control object is coupled to the exclusive-control object (step S116). If the daughter exclusive-control object is coupled to the mother exclusive-control object (Yes, step S116), then the mother exclusive-control object passes the execution right to the underlying daughter exclusive-control object (step S118). The underlying daughter exclusive-control object performs the same procedure of the event-execution control as in FIG. 10, i.e. starts the step S100 shown in the figure. If no daughter exclusive-control object exists (NO, step S116) or when the process of the daughter exclusive-control object is complete to return the control to the mother exclusive-control object, the mother exclusive-control object releases the execution right (step S114). In other words, the mother exclusive-control object passes the execution right to other context (for example, other exclusive group).

The separation of the exclusive group EG is now described below. The separation of the exclusive group means that, in the coupled one exclusive group, the exclusive group associated with the daughter exclusive-control object separates from the group associated with the mother exclusive-control object, and the separated exclusive group starts to perform an event control, i.e. the separated daughter exclusive-control object itself distributes the execution, like the mother exclusive-control object. The mother exclusive-control object from the beginning has fewer control targets than before the separation but continues to control them effectively.

More specifically, when, for example, there is a change from a situation where subscribers A, B, and C are involved in a three-way telephone conversation to a situation where one subscriber gets off the line and a disconnecting process remains for this subscriber, the exclusive group needs to be separated.

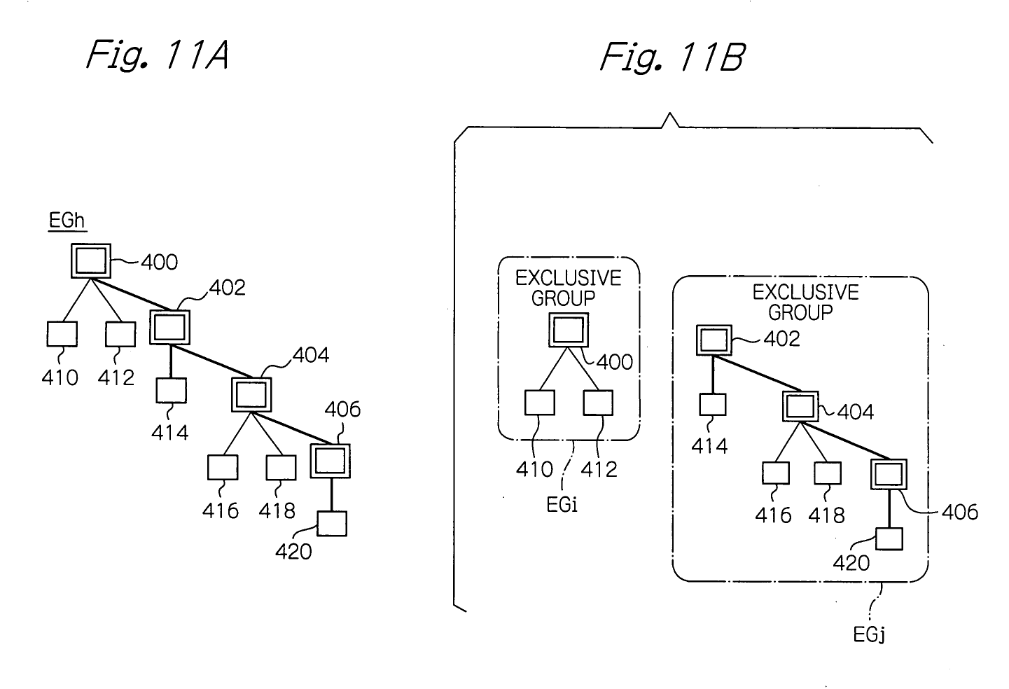

Reference will be made to FIGS. 11A and 11B for describing a specific separation of the coupled exclusive group EG. FIG. 11A shows a coupled exclusive group EGh wherein four exclusive control objects 400 to 406 are coupled, which have service object 410 to 420 respectively. The exclusive control object 400 is the mother exclusive-control object of the group Egh.

FIG. 11A and 11B show an example where the coupled exclusive group EGh is separated between the exclusive-control object 400 and the exclusive-control object 402 to form an exclusive group EGi having exclusive-control object 400 and to form an exclusive group Egj having the exclusive-control object 402 with the underlying exclusive-control objects 404 and 406, as shown in FIG. 11B. This separation may be implemented, for example, by excluding the identification information on the daughter exclusive-control object 402 from the object list stored in the mother exclusive-control object 400 of the coupled exclusive group EGh.

In the separated exclusive group Egi, the exclusive-control object 400 continues to perform, as the mother exclusive-control object, the event control in the group. In the separated exclusive group Egj, the exclusive-control object 402, which is formerly a daughter exclusive-control object, becomes a mother exclusive-control object to perform the event control in the group.

Note that it is determined in advance in a predetermined object processing the event whether or not the exclusive groups need to be separated and where to separate the group.

A description will now be given on how the service object moves in the coupled exclusive group. The movement of the service object occurs when, for example, in a call-waiting telephone service, a call-waiting subscriber changes. In such the case, the object moves at the same time from the mother to the daughter or from the daughter to the mother.

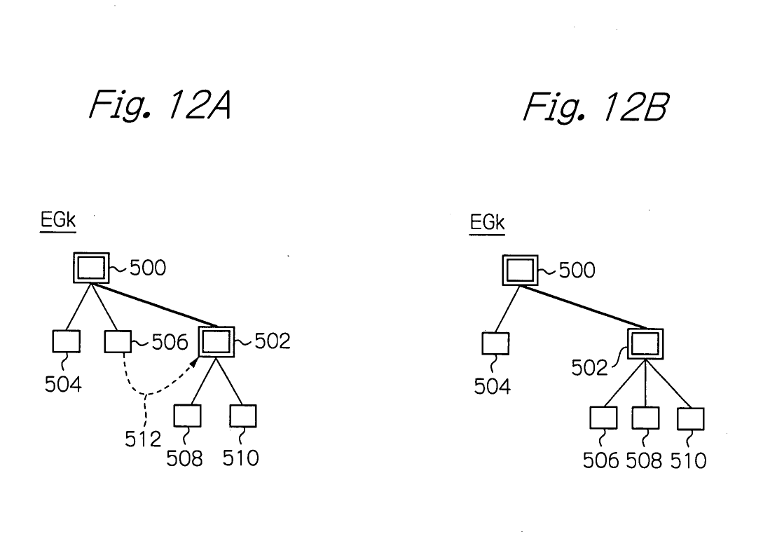

Reference will be made to FIGS. 12A and 12B for describing a specific movement of the object in the coupled exclusive group. FIGS. 12A and 12B show a coupled exclusive group EGk wherein two exclusive control objects 500 and 502 are coupled. The exclusive control object 500 has two service objects 504 and 506 and is the mother exclusive-control object of the group Egk. The exclusive control object 500 also has two service objects 508 and 510 and is the daughter exclusive-control object subordinated the mother exclusive-control object 500.

The example shown in FIGS. 12A and 12B is the case where the service object 506 of the mother exclusive-control object 500 comes to belong to the daughter exclusive-control object 502 as indicated by the arrow 512 in FIG. 12A.

The object 506 of the mother exclusive-control object 500 can move to the partial exclusive group of the daughter exclusive-control object 502 in the same exclusive group EGk. The object 506 moves, together with the non-priority event EVN queued in the object 506, to the daughter exclusive-control object 502, as shown in FIG. 12B, with the execution order of the event EVN placed at the end.

It is determined in advance whether or not the service object needs to move in the coupled exclusive group and which service object needs to move in a predetermined object processing the event.

In the movement as shown in FIGS. 12A and 12B, the exclusive-control object 500 has the object list, which is stored in it, excluding the identification information on the service object 504, and the exclusive-control object 502 has the object list, which stored in it, adding the identification information on the service object 506.

Note that, although FIGS. 12A and 12B show the service object moving from the mother exclusive-control object to the daughter exclusive-control object, the service object may move from the daughter exclusive-control object to the mother exclusive-control object.

The present invention described above has one or more of the following advantages.

The present invention can appropriately perform the exclusive control of the events when a variety of events are generated in a congested state to establish a service for the same user, i.e. the same providee.

In the present invention, the requested events are separated in the exclusive group into the priority event and the non-priority event to be managed, thus strictly maintaining the event order.

When the number of service objects contained in the same exclusive-control object is changed by the stage or state of the service, the total queue length can dynamically change because each service object has a queue length, so that the queue array does not need to be acquired in advance, thus saving the memory resource and addressing the events generated in a congested state.

The queue length is not recognized by the exclusive-control object but by each service object, thus being adaptable for a variety of services.

The priority event and non-priority event (particularly, their queues) are stored in the memories in the different objects and are loosely-coupled, so that each queue can be operated in a different context without generating the context competition, thus providing a rapid queuing operation.

The present invention can be provided for the real-time service that modifies objects forming a service when the service is in transition or execution.

The present invention can provide an object virtual network that allows for event communication between objects each being generated based on the object-orientation, and also has the user processing portion needing no own consideration of the exclusion or order of the events, thus constructing a consistent object model to ensure the constant performance quality.

In the present invention, since the service object has the queue array, when the service object is removed from the exclusive group, the operations necessary for the removal can be accomplished only by handling the queue array arranged in the relevant object.

Moreover, it is possible to retrieve the corresponding event queue in the queue array without linearly searching all the queue array in the exclusive group thereby providing the immediate handling of the corresponding event queue and rapid handling of the queue array.

The exclusive groups can be coupled by regarding the exclusive group (daughter exclusive group) as one service object, thus allowing the order of the priority events and non-priority events to be controlled by the mother exclusive-control object.

In the present invention, the exclusive groups can be coupled or separated to allow for, even for a service using a plurality of inputs/outputs for example, collective management of the exclusive control of the inputs/outputs, thus the present invention being provided for the complicated services.

In the present invention, it is possible to move one input/output to a different service in, e.g. a service having a plurality of inputs/outputs.

The multitask processor and method of the present invention are applicable to a system that has, as described above in connection with the illustrative embodiment, an alone or grouped objects, and provides a service by inputting or outputting the event to or from the object.

The present invention may also apply to, for example, a telephone switching system such as a media gateway controller (MGC). The present invention may also apply to, for example, a Web application server or the like.

The entire disclosure of Japanese patent application No. 2006-58438 filed on Mar. 3, 2005, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. An exclusive control method in a multitask system in which a single main controller executes events under an exclusive control by a service-providing program running under the system, the events being generated in a congested state, said method comprising the steps of:
defining an exclusive group that comprises an exclusive-control object having one or more service objects belonging thereto contained, which are necessary to provide the service to a same providee;
separating the events, on a basis of respective execution urgency, into a priority event that preferentially executes a process and a non-priority event;
allowing each of the service objects to comprise a non-priority-event queue that contains a non-priority event associated with the service object;
providing a link over all non-priority events in the exclusive group, which are queued in the non-priority-event queues in the service objects;
allowing the exclusive-control object to comprise a priority-event queue that contains a priority event; and
having the exclusive-control object executing preferentially the priority-event that is queued in the priority-event queue to the non-priority-events that are provided with the link and are queued in the non-priority-event queues in the service objects when the exclusive group obtains an execution right.

2. The method in accordance with claim 1, further comprising the step of depending on a nature or a stage of the provided service to add a service object in the exclusive group, or to remove a predetermined service object from the exclusive group with a new link provided to the non-priority events.

3. The method in accordance with claim 1, further comprising the step of coupling, depending on a nature or a stage of the provided service, a plurality of exclusive groups to provide a mother-daughter relation between the exclusive-control objects in the exclusive groups with each of the exclusive-control objects maintaining a contained condition of the service object.

4. The method in accordance with claim 3, wherein the mother exclusive-control object performs the exclusive control of the daughter exclusive-control object in the same way as for the service object contained by the mother exclusive-control object.

5. The method in accordance with claim 3, further comprising the step of breaking, depending on a nature or a stage of the provided service, the mother-daughter relation between two of the exclusive-control objects to divide the coupled exclusive group into two exclusive groups.

6. The method in accordance with claim 3, further comprising the step of moving, depending on a nature or a stage of the provided service, the service object in the coupled exclusive group.

7. The method in accordance with claim 6, further comprising the step of changing an exclusive-control object to which the service object is to belonging.
